(19) United States
(12) Patent Application Publication
(10) Pub. No.: US 2008/0307500 A1
(43) Pub. Date: Dec. 11, 2008

(54) USER IDENTITY MANAGEMENT FOR ACCESSING SERVICES

(75) Inventor: Guillaume GARNIER DE FALLETANS, Paris (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM, Paris (FR)

(21) Appl. No.: 12/133,423

(22) Filed: Jun. 5, 2008

(30) Foreign Application Priority Data
Jun. 5, 2007 (FR) 0755491

(51) Int. Cl. H04L 9/32

(52) U.S. Cl. 726/3

(57) ABSTRACT

Previously, a first server generates the identity of the user of a terminal. A second server generates a digital identification file concerning the user and including at least one access attribute for access to a first server. In response to a request relating to a service from the terminal to a third server dispensing the service, the reference of a selected file selected by the user is transmitted from the terminal to the second server. The second server transmits the access attribute to the terminal so that the terminal transmits it to the third server. The third server requests in conjunction with this attribute an authentication of the user by the first server. When the user is authenticated, an authentication file is stored and the user identity is transmitted from the first server to the third server that enables the requested service to be transmitted to the terminal.

### BACKGROUND OF THE INVENTION

1—Related Applications

The present application is based on, and claims priority from, French Application Number 0755491, filed Jun. 5, 2007, the disclosure of which is hereby incorporated by reference herein in its entirety.

2—Field of the Invention

The present invention relates to user identity management to simplify access to services of at least one service provider via a telecommunication network. More particularly, the invention deals with a method and a system for managing the identity of a terminal user to facilitate the authentication of said user by a service provider server offering the user personalized services.

3—Description of the Prior Art

When a user wants to access a service offered by the server of a service provider via a telecommunication network like the Internet, the user must create with the provider an account including authentication information and personal information concerning the user, called user attributes, which form the identity of the user. These personal attributes are accessible to the service server once the user has been successfully authenticated.

Today, each time a user logs on to a different service server, he creates another account with another identity including other authentication and personal information. The more accounts the user creates, the more complex the identity management becomes. Far too much user information circulates on the Internet without the user being able to control it. Moreover, when the user wants to modify a personal information item, for example one of his addresses, he must modify it in all the accounts created in the service servers, which is difficult to manage.

One technical solution represented in FIGS. 1A and 1B overcomes the identity management problem.

As shown in FIG. 1A, a user identity management system comprises a user terminal TE including an identity selector, a service server SSV and an identity server SID. The terminal and the servers can communicate via a telecommunication network RT. The identity selector of the terminal TE stores one or more digital user identification files, also called identification cards, which are classified, for example, according to user profiles: personal, leisure and professional. When the terminal TE first connects to the identity server SID, the terminal TE transmits personal attributes of the user to the identity server SID in order to create an identity account. Then, the identity server SID generates a digital identification file stored in conjunction with the personal attributes received from the user, and transmits the digital identification file to the identity selector of the terminal TE.

Referring to FIG. 1B, in the step A1, the terminal TE of the user opens a network session to connect to the service server SSV and transmits to it a service request RQS. The service server responds to it with an identity request RQI including identity criteria required by the service SSV, in a step A2. Based on these criteria, the identity selector in the terminal TE preselects the digital identification file or files, and displays them to the user to select one of them, in a step A3. The terminal TE connects to the identity server SID and transmits to it an authentication request RQJ including, among other data, the reference of the digital identification file and of the required attributes, in a step A4. In a step A5, the server SID authenticates the user of the terminal TE. When the terminal is correctly authenticated, the server SID transmits an authentication token and personal attributes of the user to the selector of the terminal TE, in a step A6. In a step A7, the user approves the reception of the token. In a step A8, the terminal transmits the token and the personal attributes received on the service server SSV in an identity response RPI. In a step A9, the service server SSV personalizes the service S requested by the user, transmits a service response RPS including the customized service S to the terminal.

The advantage of this solution is that it centralizes the personal attributes of the user in an identity server and transmits them to one or more service servers when the user is correctly authenticated by the identity server SID. On connecting to another service server and creating another account with the service provider of this other server, the user must repeat the procedure.

This solution requires, on each connection to another service server, in one and the same network session and with an identical or different digital identification file, the user of the terminal TE to be authenticated once again with the identity server SID. There is no provision for federation between the digital identification files of one and the same user sharing the same identity server. Several connections of the user terminal to service servers in one and the same network session require as many identical authentications of the user by the identity server as there are connections, and thus redundant and pointless processing times.

Also, the authentication of the user by the use of a digital identification file is handled only by the identity server which generated the file. Other identity servers that have not generated the file cannot authenticate the user and confirm the identity of said user.

### SUMMARY OF THE INVENTION

The present invention remedies the drawbacks described above with a method for authenticating a user of a terminal communicating with a first server, characterized in that it includes:

previously, generating a digital identification file identifying the user and including at least one access attribute for access to a second server, and

transmitting an authentication request concerning the user by the first server to the second server designated by the access attribute.

Thus, thanks to the access attribute included in the identification file, the first server, in particular a service server, can request an authentication with a second server, in particular an identity server, designated by the access attribute. The user terminal is therefore no longer forced to connect to the identity server and transmit an authentication request to it.

The method can also include storing an authentication file indicating that the user is authenticated in the second server on a network session. The stored authentication file includes an indication concerning the success in authenticating the user who is then deemed to be authenticated in the second server, and so has the advantage during this network session of being used for other service requests from the user addressed to the service server or to other service servers.

In a more detailed way, the method can comprise:

previously, a generation of the identity of the user in the second server, the generation of the digital identification file of the user including at least one attribute for accessing the second server in a third server, and a transmission of the file to the terminal, and

following a request by the terminal of a service dispensed by the first server, a transmission of a reference of the file from the terminal to the third server which then transmits the access attribute to the terminal, a transmission of the access attribute from the terminal to the first server, the transmission of the authentication request concerning the user by the first server to the second server designated by the access attribute and, if the user is authenticated, the storage of the authentication file and a transmission of the identity of the user by the second server to the first server which then transmits the requested service to the terminal.

According to one aspect of the invention, the digital identification file also includes an attribute for accessing a fourth server, called attribute server, managing the personal attributes of the user. Following the authentication of the user by the first server, personal attributes of the user are requested by the first server from the fourth server to personalize the service requested by the user according to said personal attributes. The personal attributes of the user are thus stored only in the fourth server.

The method of the invention can also comprise a transmission of authentication characteristics specific to the service requested by the first server to the terminal, and a selection by the user of the digital identification file from several digital identification files of the user including attributes for accessing at least the second server. The selected digital identification file can then be transmitted with the authentication characteristics from the terminal to the third server in order for the third server to select the second server whose access attribute is included in the selected digital identification file if the second server is matched to the authentication characteristics. These characteristics can thus be imposed on the second server by the first server to which the user has sent a service request. For example, the authentication characteristics can comprise a designation of the desired communication protocol between the first server and the second server via the terminal of the user, and an authentication severity level demanded by the requested service.

The invention also relates to a management system for authenticating a user of a terminal able to communicate with a first server. The system is characterized in that it includes:

means for generating a digital identification file identifying the user and including at least one access attribute for access to a second server, and

means for transmitting an authentication request concerning the user from the first server to the second server designated by the access attribute.

Moreover, the invention also relates to a terminal relative to a user to be authenticated, the terminal being able to communicate with first, second and third servers, this terminal comprising:

means for transmitting a reference of a digital identification file of the user from the terminal to the third server which is then able to transmit to the terminal an attribute for access to the second server, following a request by the terminal for a service dispensed by a first server, the digital identification file including at least the access attribute and being generated in the third server, and

means for transmitting the access attribute to the first server which is then able to transmit an authentication request concerning the user to the second server designated by the access attribute, the second server being able to transmit the identity of the user to the first server if the user is authenticated, the first server then being able to transmit the requested service to the terminal.

The invention also relates to an identity server for authenticating a user of a terminal able to communicate with another server, which is characterized in that it includes means for receiving an authentication request concerning the user and transmitted from the other server, the identity server being designated by an access attribute included in a digital identification file identifying the user and generated previously, and means for authenticating the user.

The invention also relates to a service server able to dispense a service to a user of a terminal to be authenticated and able to communicate with another server, which is characterized in that it includes means for receiving an access attribute for access to said other server, the access attribute being included in a digital identification file identifying the user and generated previously, and means for transmitting an authentication request concerning the user to said other server designated by the access attribute.

The invention also relates to a digital identification file management server for identifying a user, said management server being able to communicate with a terminal of the user, characterized in that it includes means for generating a digital identification file identifying the user and including at least one attribute for access to a server able to receive an authentication request from the terminal of the user.

Finally, the invention relates to computer programs able to be implemented respectively in an identity server according to the invention, in a service server according to the invention and in a digital identification file management server according to the invention, to implement the method of the invention.

### BRIEF DESCRIPTION OF THE DRAWINGS

Other characteristics and advantages of the present invention will become more clearly apparent from reading the following description of several embodiments of the invention, given by way of nonlimiting examples, with reference to the corresponding appended drawings in which:

FIG. 1A is a schematic block diagram of a known identity management system;

FIG. 1B is an algorithm of the identity management method according to the prior art implemented by the system of FIG. 1A;

FIG. 2 is a schematic block diagram of an identity management system according to the invention;

FIG. 3 is a more detailed schematic block diagram of the system of the invention represented in FIG. 2;

FIG. 4 is an algorithm of an identity management establishment method according to the invention; and

FIG. 5 is an algorithm of an identity management method according to the invention.

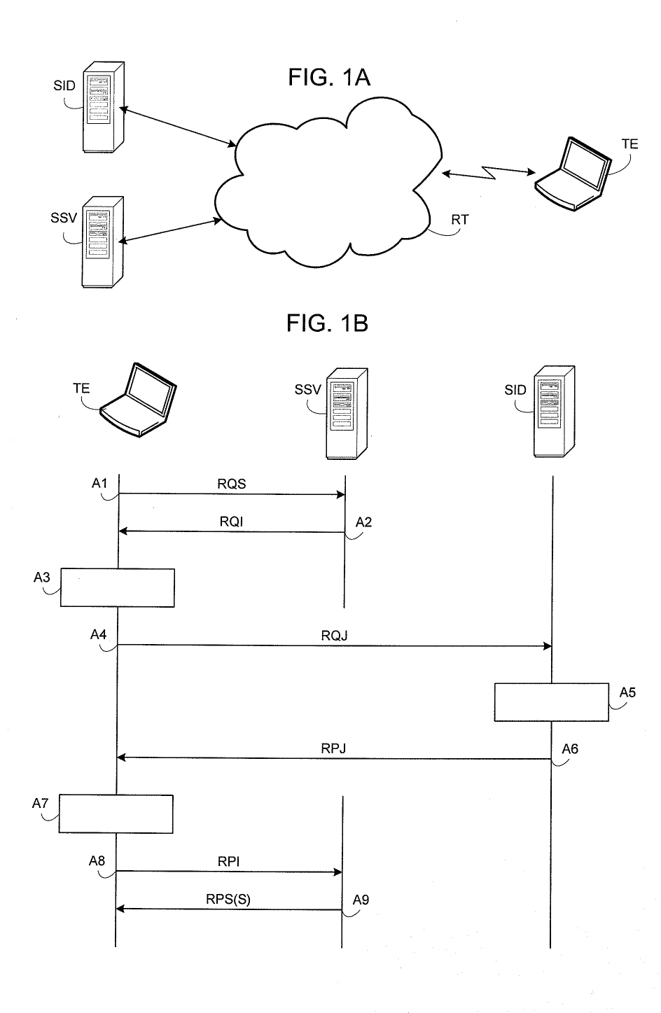

### DESCRIPTION OF THE EMBODIMENTS

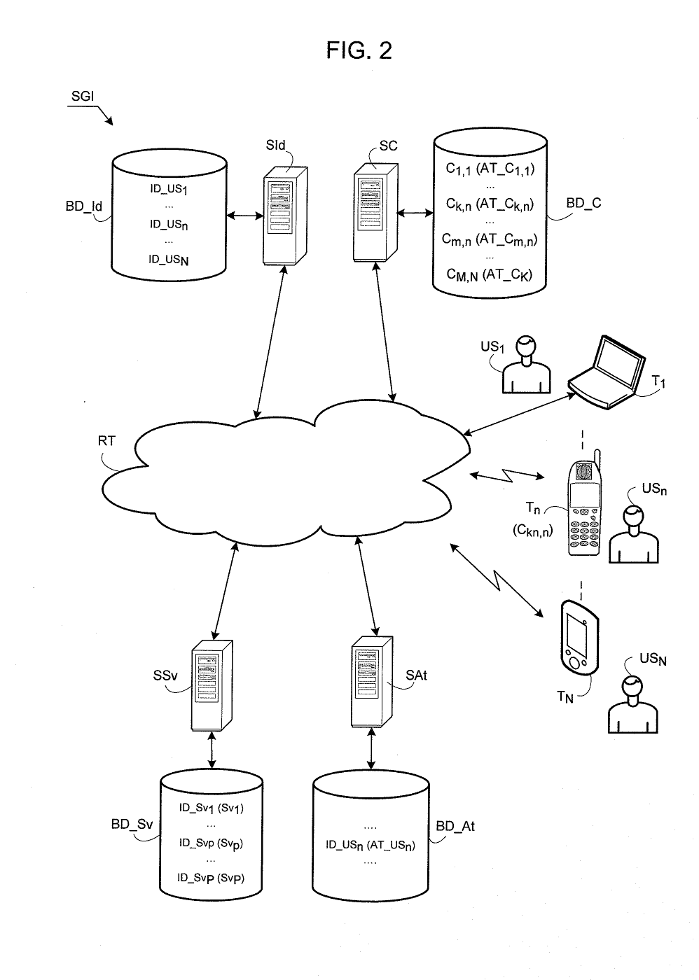

Referring to FIG. 2, an identity management system SGI comprises a terminal Tₙ of a user USₙ, such as a mobile radio terminal, among other terminals T₁ to T_{N} communicating via a telecommunication network RT with server means, with 1≦n≦N. The server means are: a service server SSv, an identity server SId, a digital identification file server SF and an attribute server SAt. According to one example, the telecommunication network RT comprises a cellular radiocommunication network of the GSM or UMTS type, comprising mobile radio terminals such as the terminal Tₙ, attached to a packet-switched network such as the Internet, comprising server means and other terminals connected to the packet-switched network.

The servers SF, SId, SSv and SAt are linked to or respectively contain databases, BD_F, BD_Id, BD_Sv and BD_At. The servers SF, SSv and SAt are federated with the server SId which means that they know it and trust it.

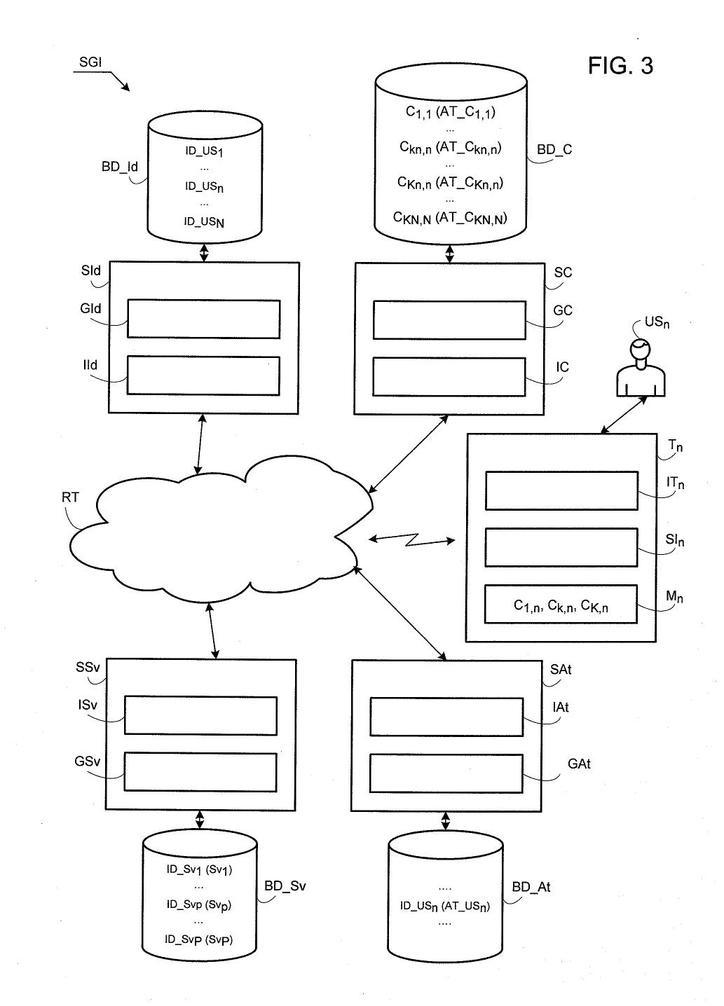

Referring to FIG. 3, only the entities Tₙ, SId, SF, SAt and SSv are represented in functional block form, most of the handling functions having a link with the invention and possibly corresponding to software and/or hardware modules.

The service server SSv is managed by a service provider offering one or more services such as book or travel ticket purchasing services or travel services.

The service server SSv comprises a communication interface ISv and a service manager GSv linked to the database BD_Sv. The interface ISv receives and transmits requests, responses and messages from and to other entities via the telecommunication network RT. The service manager GSv manages services Sv₁ to SVₚ, the functionalities of which are stored in the database BD_Sv in association respectively with service identifiers ID_Sv₁ to ID_Svₚ, which are, for example, memory location addresses. The identity management system SGI can comprise other service servers relating to other service providers.

At the request of the user USₙ by means of his terminal Tₙ, a service Svₚ dispensed by the server SSv, with 1≦p≦P, is transmitted to the terminal Tₙ after a confirmation of the identity of the user following the reception by the service server SSv of an identity ID_USₙ of the user USₙ transmitted by the terminal Tₙ and certifying the authentication of the user with the identity server SId.

The identity server SId is managed by an identity provider such as a radiocommunication network operator, a bank, or a company identifying its employees. The identity server SId comprises a communication interface IId and an identity manager GId linked to the database BD_Id. The interface IId receives and transmits requests, responses and messages to the other entities via the telecommunication network RT. The identity manager GId generates and manages identities ID_US₁ to ID_US_{N} stored in the database BD_Id. These identities ID_US₁ to ID_US_{N} are specific to the users US₁ to US_{N} of the telecommunication network RT who have created an identity account with the identity provider of the server SId.

The identity manager GId is also responsible for the authentication of users requested by service servers and stores, for each user, if the authentication of the latter is correct, a valid authentication file ER in association with authentication data of the user and/or the identity of the user.

The identities are transmitted from the server SId via the user terminals to the service servers which have requested them to confirm the correct authentication of the users wishing to obtain services. Each identity is stored in the database BD_Id in association with authentication information relating to the corresponding user. The authentication data relating to a user is, for example, a password, a fingerprint, authentication keys and/or an identifier of an entity personal to the user such as a chip card.

Other identity servers, called ancillary identity servers, relating to other identity providers, can be present in the identity management system SGI. All the ancillary identity servers are federated to the identity server SId in a partnership entered into between the various providers managing the ancillary identity servers and the provider managing the identity server SId. The ancillary identity servers can also be managed by radiocommunication network operators, banks or any other identity provider.

The file server SF knows and trusts all the ancillary identity servers federated to the identity server SId.

The file server SF comprises a communication interface IC and a file manager GF linked to the database BD_F. The interface IF receives and transmits requests, responses and messages to the other entities via the telecommunication network RT. The file manager GF generates and manages digital files, also called identification cards, stored in the database BD_F when user identity accounts are created with identity providers. Each digital identification file F_{kn,n} is generated, allocated and transmitted to a single user. Several digital identification files F_{1,n}, . . . F_{kn,n}, . . . F_{Kn,n} can belong to one and the same user USₙ, with 1≦kₙ≦Kₙ and 1≦n≦N. Each generated digital identification file F_{m,n} is also stored in the database BD_F and includes file attributes AT_F_{kn,n}.

The attributes of a digital identification file are in particular:

a mandatory access attribute for accessing an identity server, such as the server SId or an ancillary identity server, of an identity provider with which the user has created an identity account which leads to the generation of the digital identification file by the file manager GF of the file server SF, the access attribute being, for example, an address for accessing the server SId;

an attribute for accessing an attribute server, such as the server SAt, managing in particular personal attributes At_USₙ of the user USₙ;

a protocol attribute designating the communication protocol or protocols for setting up a communication with the identity server whose access address corresponds to the first preceding attribute of the file to authenticate the user;

an attribute identifying a partnership between several identity providers; for example, a partnership between a radiocommunication network operator and a bank with which the user has created identity accounts; and

a severity attribute designating the severity level or levels for authenticating the user proposed by the identity server SId.

A severity level for the authentication of the user USₙ proposed by the identity server and demanded by the service provider can be weak, average or strong. For a weak authentication, the user must, for example, provide the identity server with a password. For a medium authentication, the user must, for example, provide the password accompanied by a physical authentication means such as a chip card to be inserted into a reader of the terminal Tₙ. For a strong authentication, the user must, for example, provide several factors on which the authentication depends, such as a password and/or a physical authentication means such as a physical fingerprint or voice print, and/or a code transmitted by the identity server to another communication device of the user, for example in a short message, and retransmitted by the terminal of the user to the identity server.

Other file attributes can be included in the identification file.

The file manager GF also transmits a token JA to the terminal of the user to authorize the latter to use the digital identification file and the attributes that are included therein in order to be authenticated.

The attribute server SAt comprises a communication interface IAt and an attribute manager GAt linked to the database BD_At. The interface IAt receives and transmits requests, responses and messages to the other entities via the telecommunication network RT. The attribute manager GAt manages the personal attributes of each user.

The personal attributes AT_USₙ of the user USₙ are, for example:

identity information such as the name, first name, age, date of birth and a digital photograph of the user USₙ,

correspondence identifiers such as the email address, fixed telephone number, home address of the user USₙ,

geolocation data,

presence information, and

other personal information concerning the user USₙ such as an address book, an availability timetable, competences.

All these personal attributes can be partly or wholly accessible by the service server SSv in order to personalize the service Svₚ requested by the user according to his personal, professional or leisure profile, for example.

The personal attributes AT_USₙ of the user USₙ are stored in the database BD_AT in association with the identity ID_USₙ of the user generated by the identity server SId, when the identity account of the user is created with an identity provider.

The identity server SId, the file server SF and the attribute server SAt can communicate with each other directly by a wired link or by a high speed packet network, for example the Internet or an Intranet. According to a first embodiment, the three servers SId, SF and SAt are located in and/or merged into a single server managed by the same provider, so reducing addressing constraints. According to a second embodiment, the three servers are located with separate providers and then communicate by secure links.

The terminal Tₙ of the user USₙ comprises a communication interface ITₙ, a digital identification file selector SIₙ and a memory Mₙ. The terminal Tₙ optionally includes a display such as a screen connected to or incorporated in the terminal and associated in particular with a keyboard connected to or incorporated in the terminal. The interface ITₙ receives and transmits requests, responses and messages to other entities via the telecommunication network RT. The digital identification file selector SIₙ manages the identification files F_{1,n} to F_{Kn,n} of the user that have each been generated by the file server SF before being transmitted and stored in the memory Mₙ of the terminal Tₙ. The memory Mₙ is a nonvolatile memory of the ROM or EEPROM type.

The terminal Tₙ can be any personal communication device communicating with an identity server SId, a digital identification file server SF and a service server SSv via a telecommunication network RT. These personal devices are, for example, a mobile radio terminal, a communicating personal digital assistant PDA or a home terminal, portable or otherwise, such as a video games console or an intelligent television receiver cooperating with a remote control with display or alphanumeric keypad serving also as a mouse via an infrared link.

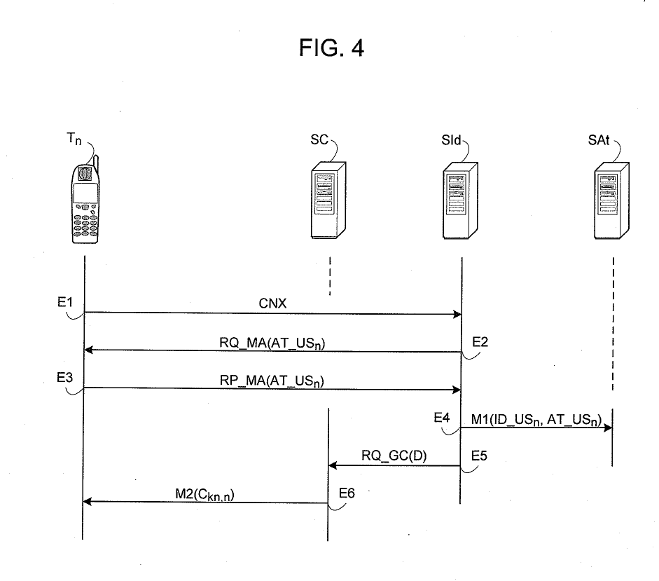

Referring to FIG. 4, the algorithm for setting up an identity account for a user USₙ with an identity provider, comprises steps E1 to E6.

The user account is created beforehand in an agency of the identity provider. According to one example, the user wants to subscribe to a mobile radiocommunication rate plan of a cellular radiocommunication network operator corresponding to an identity provider. When taking out the subscription to the rate plan in the agency of the identity provider, the user gives personal attributes that may or may not be useful to the subscription. The provider then creates an identity account for the user USₙ of the terminal Tₙ by means of the identity server SId. The identity manager GId of the identity server SId generates an identity ID_USₙ specific to the user USₙ and stores it in the database BD_Id in association with authentication data of the user. The personal attributes AT_USₙ of the user are also prestored in the database BD_Id.

As a variant, the attributes AT_USₙ of the user are transmitted by the identity server SId accompanied by the generated identity ID_USₙ to the attribute server SAt which stores them in the database BD_At. According to this variant, either the attribute server SAt is incorporated in the identity server SId, or the attributes AT_USₙ and the identity ID_USₙ are transmitted via the telecommunication network RT.

According to another example, the user opens a bank account in a bank corresponding to an identity provider. According to a final example, the user is an employee of a company ET which creates identity accounts for each of its employees.

Then, for example, when the terminal Tₙ is powered up by the user USₙ, the terminal Tₙ opens a first connection CNX to the identity server SId via the telecommunication network RT, in the step E1.

In the step E2, in order to confirm the creation of the identity account of the user USₙ of the terminal Tₙ, the identity server SId uses its identity manager GId to create a personal attribute modification request RQ_MA including the personal attributes AT_USₙ of the user USₙ prestored on taking out the subscription. The request RQ_MA is transmitted to the terminal Tₙ from the interface IId.

In the step E3, the user USₙ confirms the creation of the identity account by transmitting, from its terminal and by means of the interface ITₙ, an attribute modification response RP_MA including the personal attributes AT_USₙ, modified or otherwise.

When the modification response is received by the interface IId, the identity server SId transmits a message M1 to the attribute server SAt. The message M1 contains the confirmed personal attributes AT_USₙ of the user USₙ, accompanied by the identity of the user ID_USₙ, in the step E4. When the message M1 is received by the interface IAt, the attribute manager GAt of the server SAt orders the attributes AT_USₙ to be stored in association with the identity ID_USₙ of the user in the database BD_At. The attribute server SAt optionally transmits a confirmation of receipt of the attributes to the identity server SId.

In the step E5, the identity server SId transmits a request RQ_GF via the interface IId to the file server SF to generate an identification file. The request includes data D designating in particular the identity provider, the attribute provider, the authentication severity level or levels demanded, and the communication protocol or protocols used by the identity server SId. The request RQ_GF can also contain the address for accessing the terminal Tₙ.

When the request RQ_GF is received by the interface IF, the manager GF of the file server SF generates a digital identification file F_{kn,n} and establishes file attributes AT_F_{kn,n} according to the data D transmitted in the request RQ_GF. The file manager GF stores the file F_{kn,n} including the established file attributes AT_F_{kn,n} in the database BD_F. The file server SF optionally transmits, via its interface IF, a confirmation that the digital identification file has been generated to the identity server SId.

In the step E6, the interface IF of the file server SF transmits a message M2 including the generated digital identification file F_{kn,n} with no attributes to the terminal Tₙ of the user USₙ. The digital identification file received by the interface ITₙ of the terminal Tₙ is stored in the memory Mₙ under the control of the digital identification file selector SIₙ.

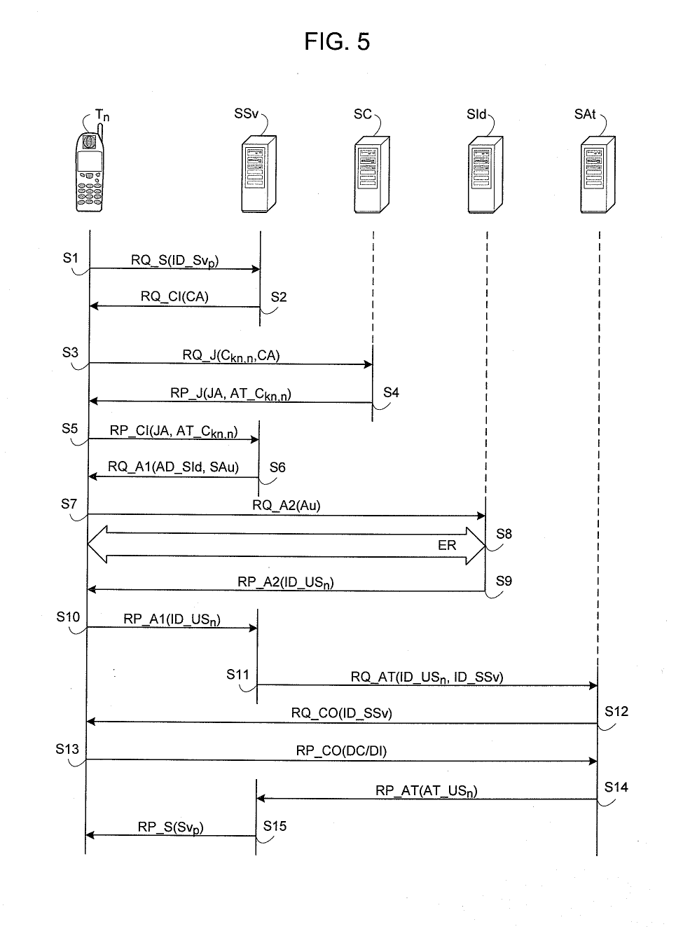

Referring to FIG. 5, the method of managing the identity of a user USₙ wishing to obtain a service Svₚ from the service server SSv comprises steps S1 to S15.

In the step S1, the user USₙ opens a network session and the terminal Tₙ is connected to the service server SSv via the telecommunication network RT. The terminal Tₙ transmits to the server SSv a service request RQ_S including the identifier ID_Svₚ of a service Svₚ dispensed by the server SSv, stored in the database BD_Sv.

The interface ISv of the service server receives the request RQ_S. To identify the user before transmitting the customized service to him and/or creating a personalized service account for him, the service manager GS of the server SSv creates a request RQ_FI to obtain a digital identification file of the user. The digital identification file will help to initiate the authentication of the user and obtain file attributes of the user necessary to access the personal attributes of the user in order to personalize the service or the service account to be created. The request RQ_FI contains authentication characteristics CA necessary to the requested service Svₚand corresponding to some of the file attributes of the user USₙ. The characteristics CA comprise, for example, the identifier of the identity server SId and/or of the desired identity provider, and/or an identifier of a partnership between several desired identity providers, and the type of communication protocol desired between the service server and the identity server via the terminal of the user, and the authentication severity level required depending on the requested service, for example a strong authentication if the service requires high security. In the step S2, the interface ISv of the server SSv transmits the request RQ_FI to the terminal Tₙ.

The digital identification file selector SIₙ in the terminal Tₙ interprets the request RQ_FI received by the interface ITₙ. The identity selector SI orders the display of the digital identification files F_{1,n} to F_{Kn,n} read in the memory Mₙ via the display of the terminal Tₙ.

In the step S3, the user USₙ selects a file F_{kn,n} that it wants to use and that is associated with the identity server SId. The file selector SIₙ creates an authorization token request RQ_J including the reference of the selected digital identification file F_{kn,n} and the authentication characteristics CA, in order to be authorized with the file server SF to use the selected digital identification file. The request RQ_J is transmitted by the interface ITₙ of the terminal Tₙ to the interface IF of the file server SF.

In the step S4, the file manager GF of the server SF searches in the database BD_F for the attributes AT_F_{kn,n} included in the selected file F_{kn,n}, the reference of which is extracted from the received request RQ_J, and compares them to the authentication characteristics CA extracted from the received request. If the identity server referred to by the digital identification file F_{kn,n} in the database BD_F is suited to the authentication characteristics CA specific to the service requested by the service server, notably to the communication protocol designated in the authentication characteristics, the file server SF creates a response RP_J including an authorization token JA and some or all of the attributes AT_F_{kn,n} of the file F_{kn,n} corresponding to the authentication characteristics CA. The interface IF of the server SF transmits the response PR_J to the terminal Tₙ. Otherwise, if the selected file does not correspond to the characteristics supplied by the service server, the file server SF reports this to the terminal Tₙ which prompts the user USₙ to select another identity file.

In the step S5, the digital identification file selector SIₙ creates a response RP_FI to the request RQ_FI transmitted by the server SSv in the step S2. The response RP_FI contains the authorization token JA and the file attributes AT_F_{kn,n} transmitted by the file server SF in the step S4. The file attributes AT_F_{kn,n} are, for example, the address AD_SId for accessing the identity server, the address AD_SAt for accessing the attribute server and the type of communication protocol wished. The interface ITₙ of the terminal Tₙ transmits the response RP_FI to the service server SSv.

The manager GSv of the service server stores the file attributes AT_F_{kn,n} in the response RP_FI received by the interface ISv.

The steps S6 to S10 relate to the authentication of the user USₙ.

In the step S6, the service server SSv redirects the terminal Tₙ to the identity server SId by transmitting to it a first authentication request RQ_A1 including the address AD_SId for accessing the identity server SId and the authentication severity level SAu required, for example a strong authentication.

In the step S7, the terminal Tₙ retransmits to the identity server SId the request RQ_A1 in the form of a request RQ_A2 including the required authentication severity level SAu. The retransmission of the authentication request is transparent to the user USₙ who sees on the display of the terminal Tₙ only an authentication page transmitted by the identity server SId following the request RQ_A2.

The step S8 is a series of exchanges between the terminal Tₙ of the user and the identity server SId to authenticate the user. The identity server requests authentication data of the user USₙ, variable according to the severity level demanded, to be matched to the authentication data stored in the database BD_Id.

When the user USₙ is deemed authenticated by the identity manager GI of the identity server, the latter searches in the database BD_Id for the identity ID_USₙ of the user stored in association with the authentication data of the user, and also stores, in association with the authentication data, the valid authentication file ER indicating the successful authentication of the user. The manager GI then creates a response RP_A2 to the second authentication request RQ_A2 transmitted in the step S7. The response RP_A2 contains the identity ID_USₙ of the user. In the step S9, the interface IId of the service server SId transmits to the terminal Tₙ the response RP_A2.

To confirm the correct authentication of the user to the service server SSv in the step S10, the terminal Tₙ redirects to the server SSv the identity ID_USₙ in a response RP_A1 to the first authentication request RQ_A1 transmitted in the step S6.

In the step S11, the service manager GSv recovers the identity ID_USₙ extracted from the response RP_A1 received by the interface ISv. The manager GSv searches in the file attributes AT_F_{k,n} stored in the server SSv for the address AD_SAt for accessing the attribute server managing the personal attributes AT_USₙ of the user USₙ in order to personalize the requested service. The manager GSv also searches in the database BD_Sv for the service SVₚ requested by the user in the step S1, and creates an attribute request RQ_AT including the identity ID_USₙ of the user USₙ, an identifier ID_SSv of the service server and personal attribute types sought according to the service to be personalized. The request RQ_AT is transmitted from the interface ISv to the attribute server SAt in order to obtain the personal attributes requested of the user.

The interface IAt of the attribute server SAt receives the request RQ_AT and transmits it to the attribute manager GAt in order to be processed.

In the step S12, the manager GAt creates a confirmation request RQ_CO confirming the access to the attributes. The request RQ_CO includes the identifier ID_SSv of the server SSv and is transmitted by the interface IAt to the terminal Tₙ.

After the request has been received by the interface ITₙ, the digital identification file selector SIₙ orders the display on the terminal Tₙ of an interpretation of the request RQ_CO in order for the user to confirm or deny access to his personal attributes by the service server SSv.

In the step S13, the digital identification file selector SIₙ creates a confirmation response RP_CO including a confirmation data item DC or a denial data item DI depending on the response from the user. The interface ITₙ of the terminal Tₙ transmits the response RP_CO to the interface IAt of the attribute server SAt.

In the step S14, the attribute manager GAt interprets the response RP_CO received. If the response includes the confirmation data item DC, the attribute manager GAt searches for the personal attributes of the user requested by the service server SSv and includes them in a response RP_AT to the request RQ_AT transmitted in the step S11. If the response RP_CO includes a denial data item DI, the attribute manager GAt creates a response RP_AT including no personal attributes.

In the step S15, the service manager analyzes the response RP_AT and uses the personal attributes AT_USₙ of the user extracted from the response RP_AT to personalize the service SVₚ requested by the user or to create a service account, and includes it in a service response RP_S. If no attribute has been transmitted, the manager GSv does not personalize the service SVₚ which it includes as such in a service response RP_S. The interface ISv of the service server SSv transmits the service response RP_S including the personalized or unpersonalized service SVₚ to the terminal Tₙ. According to personalization examples, when the user connects via his terminal to a service server dispensing a travel service, the service server uses the attribute relating to geolocation data of the terminal of the user to transmit to the terminal the itinerary to be followed to a predetermined destination.

The closure of the network session takes effect when the terminal Tₙ of the user USₙ disconnects from the telecommunication network RT or closes its access browser. The closure of the network session causes the valid authentication files relating to the user to be deleted by the identity manager of the identity server SId.

As long as the session is open, the user USₙ can request from the terminal Tₙ a second service from a second service server of the identity management system SGI, or more generally, several services from one or more service servers. For a second service, the user USₙ uses the digital identification file selected previously in a first case, or a second digital authentication file relating to an ancillary identity server federated to the identity server SId in a second case.

In the first case, the steps S1 to S7 of the identity management method of the invention are carried out in a way that is similar to the preceding description, the previously selected digital identification file being used. The step S8 is not carried out since the identity server SId has already stored a valid authentication file relating to the user during the same session. The same identity ID_USₙ is transmitted in the step S9. The steps S10 to S15 are carried out.

In the second case, the user USₙ selects, in the step S3, a second digital identification file relating to an ancillary identity provider federated to the identity provider SId. The file server SF transmits to the second service server via the terminal Tₙ the attributes of the second selected file relating to the ancillary identity provider, in the steps S4 and S5. The second service server requests an authentication of the user USₙ with the ancillary identity server via the terminal of the user, in the steps S6 and S7. The ancillary identity server checks with the identity server SId that the server SId has already authenticated the user in the same network session, by transmitting to it a verification request via the telecommunication network RT.

If the identity server SId has already stored a valid authentication file relating to the user in the same session, it transmits a positive response to the ancillary identity server. The ancillary identity server does not carry out the authentication step S8 and transmits, to the second service server via the terminal of the user, an identifier specific to the user and generated by the identity manager of the ancillary identity server when the identity account of the user was created with the ancillary provider.

Otherwise, if no authentication of the user has been processed by the identity server SId, the ancillary identity server carries out the step S8.

Finally, the method continues with the steps S9 to S15 described previously being executed.

Thus, the user can use a different digital identification file stored in the file server SF and including an attribute for access to an ancillary identity server federated to the identity server SId, but without the ancillary identity server needing to authenticate the user again during this same session since the user has already been authenticated by the identity server SId.

According to an exemplary application, Mr M is a client of the cellular radiocommunications operator OP which has an identity server according to the invention. The portable terminal of Mr M has stored a digital identification file F_OP relating to said operator and transmitted by the file server when his account was created with the operator OP. Furthermore, Mr M is an employee of the company ET which has a second identity server that has identified all the employees of the company ET. The portable terminal of Mr M has also stored a digital identification file F_ET relating to the company and transmitted by the file server when he was employed by the company ET.

Mr M uses his portable terminal to open a network session to access an itinerary service server SSv_ITI in order to retrieve his route to his home address. The service SSv_ITI prompts Mr M to authenticate himself using an identification file. Mr M selects the file F_OP relating to the operator to identify himself with the server SSv_ITI. The server SSV_ITI thus receives, by the file server SF via the terminal of Mr M, the attributes of the file F_OP including, among other things, the attribute for access to the server of the operator OP and the attribute for access to the attribute server federated to the server of the operator OP.

The server SSv-ITI also receives an identity ID_MOP specific to Mr M from the server of the operator OP via the terminal of Mr M, confirming his authentication with the server of the operator. To personalize the service requested by Mr M, the service server accesses the attribute server SAt and finds therein the geolocation data of Mr M, and his home address. By combining these two personal attributes, the server SSv_ITI transmits to the terminal of Mr M a file with the itinerary to be followed to reach his home.

During the same network session, Mr M decides to buy a book and connects his terminal to an on-line book purchasing service server SSv_LIV. The server SSv_LIV prompts Mr M to authenticate himself using a digital identification file. Mr M selects his file F_OP relating to the operator OP. Since he has already been authenticated previously, Mr M directly accesses a secure space of the server SSv_LIV. The server SSv_LIV receives the identity ID_MOP specific to Mr M from the server of the operator OP via the terminal of Mr M confirming his authentication with the server of the operator. Once the book has been chosen, the server SSv_LIV automatically completes the delivery form with the personal attributes of Mr M found in the attribute server SAt.

Still in the same session, Mr M wants to buy a plane ticket for a business trip required for the company ET from a ticketing server SSv_BIL. The service SSv_BIL prompts Mr M to authenticate himself using a digital identification file. Mr M this time selects the digital identification file F_ET relating to the company ET. The server SSv_BIL thus receives, by the file server SF via the terminal of Mr M, the attributes of the file F_ET including, among other things, the attribute for access to the server of the company ET and the attribute for access to the attribute server federated to the server of the company ET. Now, the company ET and the operator OP have established a partnership: each of the providers trusts the authentication offered by the other provider. The server of the company ET checks whether Mr M has a currently valid session which is confirmed by the server of the operator OP. Having been authenticated, Mr M accesses the server SSv_BIL. The service server SSv_BIL receives an identity ID_MET specific to Mr M from the server of the company ET via the terminal of Mr M confirming his authentication with the server of the company ET. Accessing the attributes characterizing the professional identity of Mr M from the attribute server federated to the identity server of the company ET, the server SSv_Ticket bills the booked tickets to the account of the company ET and delivers them to the professional address of Mr M.

The invention described here relates to a user identity management method and system, a service server, an identity server and an identification file management server. It also relates to three computer programs able to be implemented respectively in the service server, the identity management server and the identification file management server.

The computer program able to be implemented in the identity server for authenticating a user of a terminal able to communicate with another server is characterized in that it includes instructions which carry out the steps corresponding to the function means included in the identity server, when said program is executed in the identity server.

The computer program able to be implemented in the service server able to dispense a service to a user of a terminal to be authenticated and able to communicate with another server is characterized in that it includes instructions which carry out the steps corresponding to the function means included in the service server, when said program is executed in the service server.

The computer program able to be implemented in the identification file management server able to identify a user and to communicate with a terminal of said user is characterized in that it includes instructions which carry out the steps corresponding to the function means included in the identification file management server, when said program is executed in the identification file management server.

Consequently, the invention also applies to computer programs, in particular computer programs stored on a or in storage mediums readable by a computer and by any data processing device adapted to implement the invention. These programs can use any programming language and take the form of source code, object code or an intermediate code between source code and object code, such as a partially compiled form, or any other form desirable for implementing the method according to the invention.

A storage medium can be any entity or device capable of storing the programs. For example, the medium can include storage means in which the computer program according to the invention is stored, such as a ROM, for example a CD ROM or a microelectronic circuit ROM, a USB key, or magnetic storage means, for example a diskette (floppy disk) or a hard disk.

Moreover, the information medium can be a transmissible medium such as an electrical or optical signal, which can be routed via an electrical or optical cable, by radio or by other means. The program according to the invention can in particular be downloaded over an Internet type network.

Alternatively, the information medium can be an integrated circuit in which the program is incorporated, the circuit being adapted to execute or to be used in the execution of the method according to the invention.

What I claim is:

1. A method of authenticating a user of a terminal communicating with a first server, said method including:
previously, generating a digital identification file identifying the user and including at least one access attribute for access to a second server, and
thereafter transmitting an authentication request concerning said user by said first server to said second server designated by said access attribute.

2. A method according to claim 1, including storing an authentication file indicating that said user is authenticated in said second server on a network session.

3. A system for authenticating a user of a terminal able to communicate with a first server, said system including:
a generator for generating a digital identification file identifying said user and including at least one access attribute for access to a second server, and
a transmitter for transmitting an authentication request concerning said user from said first server to said second server designated by said access attribute.

4. A system according to claim 3 further including a memory for storing an authentication file indicating that said user is authenticated in said second server on a network session.

5. An identity server for authenticating a user of a terminal able to communicate with another server, said identity server including a receiver for receiving an authentication request concerning said user and transmitted from the other server, said identity server being designated by an access attribute included in a digital identification file identifying said user and generated previously, and an authenticator for authenticating said user.

6. A service server for dispensing a service to a user of a terminal to be authenticated and for communicating with another server, said service server including a receiver for receiving an access attribute for access to said other server, said access attribute being included in a digital identification file identifying said user and generated previously, and a transmitter for transmitting an authentication request concerning said user to said other server designated by said access attribute.

7. A server for identifying a user, said server being able to communicate with a terminal of said user and including a generator for generating a digital identification file identifying the user and including at least one attribute for access to a server able to receive an authentication request from said terminal of said user.

8. A computer arrangement adapted to be performed in an identity server for authenticating a user of a terminal able to communicate with another server, said computer arrangement including instructions adapted for receiving an authentication request concerning said user and transmitted from the other server, said identity server being designated by an access attribute included in a digital identification file identifying said user and generated previously, and for authenticating said user.

9. A computer arrangement adapted to be performed in a service server able to dispense a service to a user of a terminal to be authenticated and able to communicate with another server, said computer arrangement including instructions adapted for receiving an access attribute for access to said other server, said access attribute being included in a digital identification file identifying said user and generated previously, and for transmitting an authentication request concerning said user to said other server designated by said access attribute.

10. A computer arrangement adapted to be performed in a server for identifying a user, said computer arrangement including instructions adapted for generating a digital identification file identifying the user and including at least one attribute for access to a server able to receive an authentication request from said terminal of said user.
